(19) United States
(12) Patent Application Publication
(10) Pub. No.: US 2024/0383018 A1
(43) Pub. Date: Nov. 21, 2024

(54) DRAIN CLEANING DEVICE

(71) Applicant: MILWAUKEE ELECTRIC TOOL CORPORATION, Brookfield, WI (US)

(72) Inventors: Dayton J. Aardema, Menomonee Falls, WI (US); Benjamin J. Boldt, Milwaukee, WI (US); Van N. Heyer, Milwaukee, WI (US); Ameya Sanjay Kulkarni, Brookfield, WI (US); Brandon L. Yahr, Slinger, WI (US); Julia L. Savich, Shorewood, WI (US)

(21) Appl. No.: 18/662,482

(22) Filed: May 13, 2024

Related U.S. Application Data
(60) Provisional application No. 63/466,738, filed on May 16, 2023.

(51) Int. Cl. B08B 9/04

(52) U.S. Cl. CPC B08B 9/04; B08B 2209/04

(57) ABSTRACT

A drain cleaning device is configured to be used in a pipe defining a pipe diameter. The drain cleaning device includes a frame, a reservoir supported by the frame, a drum assembly supported by the frame, and a flexible hose positioned at least partially within the drum assembly. The flexible hose is configured to be extended from and retracted into the drum assembly. The flexible hose defines a first end and a second end opposite the first end. The first end is coupled to the reservoir. The drain cleaning device further includes a flexible scrubber adjacent the second end of the flexible hose. The flexible hose includes a first nozzle angled in a direction away from the flexible scrubber and a second nozzle angled in a direction toward the flexible scrubber.

### CROSS-REFERENCE TO RELATED APPLICATION

This application claims priority to U.S. Provisional Patent Application No. 63/466,738, filed May 16, 2023, the entire contents of which are incorporated herein by reference.

### FIELD

The present disclosure relates to drain cleaning devices for cleaning drains, pipes, or other conduits, and specifically, to a drain cleaner with a flexible cable and/or flexible hose.

### SUMMARY

In one aspect, a drain cleaning device is configured to be used in a pipe defining a pipe diameter. The drain cleaning device includes a frame, a reservoir supported by the frame, a drum assembly supported by the frame, and a flexible hose positioned at least partially within the drum assembly. The flexible hose is configured to be extended from and retracted into the drum assembly. The flexible hose defines a first end and a second end opposite the first end. The first end is coupled to the reservoir. The drain cleaning device further includes a flexible scrubber adjacent the second end of the flexible hose. The flexible hose includes a first nozzle angled in a direction away from the flexible scrubber and a second nozzle angled in a direction toward the flexible scrubber.

In another aspect, a drain cleaning device includes a frame, a housing supported by the frame, a motor located within the housing, a reservoir supported by the frame, a flexible cable positioned at least partially within the housing, and a flexible hose positioned at least partially within the housing. The flexible cable is configured to be extended from and retracted into the housing. The flexible cable defines a first end and a second end opposite the first end. The first end is coupled to the motor to receive torque from the motor. The flexible hose is configured to be extended from and retracted into the housing. The flexible hose defines a first end coupled to the reservoir and a second end opposite the first end. The drain cleaning device further includes a rotating cleaning attachment coupled to the second end of the flexible cable and a nozzle coupled to the second end of the flexible hose.

In another aspect, a drain cleaning device includes a housing, a motor located within the housing, a drum assembly located within the housing, and a flexible cable positioned at least partially within the drum assembly. The flexible cable is configured to be extended from and retracted into the drum assembly. The flexible cable defines a first end and a second end opposite the first end. The first end is coupled to the motor to receive torque from the motor. The drain cleaning device further includes a heating head coupled to the second end of the flexible cable and a heater element configured to transfer heat to the heating head.

### BRIEF DESCRIPTION OF THE DRAWINGS

FIG. 1 is a front perspective view of a drain cleaning device.

FIG. 2 is a cross-sectional view of a portion of a hose and a scrubber of the drain cleaning device of FIG. 1 located within a pipe.

FIG. 3 is a perspective view of multiple embodiments of scrubbers to be used with the drain cleaning device of FIG. 1.

FIG. 4 is a front perspective view of a drain cleaning device according to another embodiment.

FIG. 5 is a partial cross-sectional view of a drain cleaning attachment and a nozzle of the drain cleaning device of FIG. 4.

FIG. 6 is a partial cross-sectional view of another embodiment of a drain cleaning attachment for use with the drain cleaning device of FIG. 4.

FIG. 7 is a front perspective view of a drain cleaning device according to another embodiment.

FIG. 8 is a front perspective view of a cable and a head of the drain cleaning device of FIG. 7.

FIG. 9 is a schematic diagram of a pipe attachment for use with a drain cleaning device.

FIG. 10 is a cross-sectional view of a drum for use with a drain cleaning device, the drum including debris.

FIG. 11 is a cross-sectional view of the drum of FIG. 10 without debris.

FIG. 12 is a schematic view of a clog sensing system.

FIG. 13 is a schematic view of a clog sensing system according to another embodiment.

FIG. 14 is a schematic view of a clog sensing system according to another embodiment.

FIG. 15 is a perspective view of a universal hookup coupled to a liquid source.

FIG. 16 is an enlarged view of the universal hookup of FIG. 15 coupled to the liquid source.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

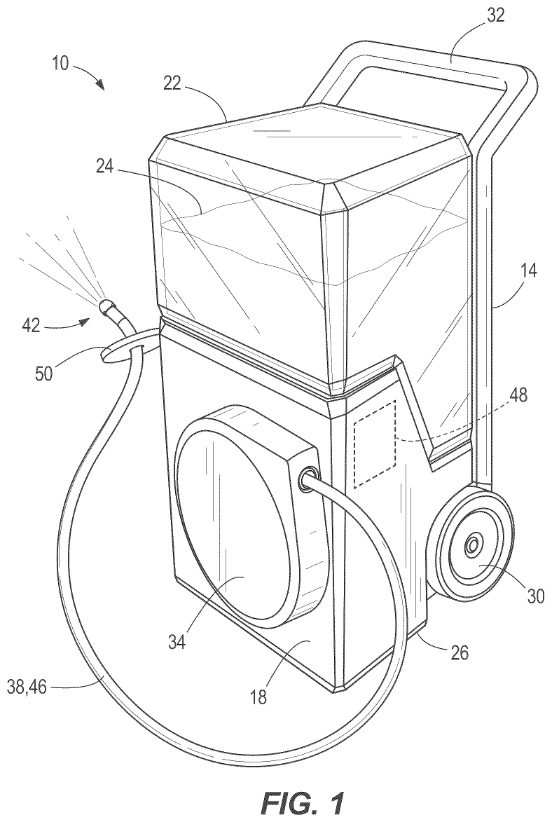

FIG. 1 illustrates a drain cleaning device 10 that is operable to clear and clean debris from pipes or other conduits. The drain cleaning device 10 includes a frame 14, a housing 18 supported by the frame 14, and a reservoir 22 coupled to the housing 18 and supported by the frame 14. In some embodiments, the frame 14 is made from a metal material such as aluminum or steel. In other embodiments, the frame 14 may be made from other materials such as plastic or the like. The frame 14 includes a stabilizing platform 26 on a bottom side to help stabilize the drain cleaning device 10 when the drain cleaning device 10 is in an upright position, as shown in FIG. 1. The stabilizing platform 26 may include stabilizing features (e.g., feet) to further stabilize the drain cleaning device 10 when in the upright position. Wheels 30 are coupled to a rear side of the frame 14 to facilitate transporting the drain cleaning device 10 across a surface. For example, the drain cleaning device 10 may be tipped onto the wheels 30 (and off of the stabilizing platform 26) to move the drain cleaning device 10 along the surface. The illustrated wheels 30 are positioned adjacent, but rearward of the stabilizing platform 26. In the illustrated embodiment, the wheels 30 are idle (i.e., non-driven wheels). In other embodiments, the wheels 30 may be driven wheels. The frame 14 includes a handle 32 on a top side, which may be grasped by a user to assist in transporting the drain cleaning device 10. The illustrated drain cleaning device 10 may further include a battery receptacle for receiving and supporting a battery pack, such as a power tool battery pack. In other embodiments, drain cleaning device 10 may support a power cord to electrically connect the drain cleaning device 10 to an AC power source.

The housing 18 is coupled to the stabilizing platform 26. The illustrated housing 18 includes a drum assembly 34. The drum assembly 34 may include an outer drum and an inner drum coupled to the outer drum for co-rotation therewith. The inner drum may have a smaller diameter than the outer drum to define a space therebetween. A drain cleaning hose 38 may be at least partially supported within the space.

The hose 38 is hollow and includes a first end, a second end 42 opposite the first end, and a body 46 therebetween. The first end is located within the housing 18 and is coupled to the reservoir 22. The second end 42 is located outside the housing 18. The body 46 is at least partially located within the space of the drum assembly 34. The second end 42 and the body 46 may be extended from and retracted into the drum assembly 34. For example, the second end 42 may be pulled by a user away from the drum assembly 34 to extend the body 46 out of the drum assembly 34 or may be pushed by a user toward the drum assembly 34 to extend the body into the drum assembly 34. In some embodiments, the second end 42 and the body 46 may be biased by a biasing member into the drum assembly 34.

The illustrated reservoir 22 is coupled to and positioned above the housing 18. The reservoir 22 is configured to contain a liquid 24 (e.g., water, cleaning fluid, soap, etc. or a combination thereof). The reservoir 22 includes a liquid inlet on an outward facing surface and a liquid outlet on a surface (e.g., a bottom surface) facing the housing 18. Said another way, the inlet is accessible by a user to fill up the reservoir 22, and the outlet extends toward the housing 18 to couple to the first end of the hose 38. In some embodiments, the reservoir 22 may be removably coupled to the housing 18. In these embodiments, the inlet and the outlet may both be located on the bottom surface of the reservoir 22. In some embodiments, the inlet and the outlet may be defined by a single aperture. A pump 48 may be located in the housing 18 to increase the flow rate of the liquid 24 from the reservoir 22 and through the hose 38. In some embodiments, the pump 48 is located between the outlet and the first end of the hose 38. The pump 48 may be selectively activated by a pump activating member (e.g., a foot switch, a button, etc.). In some embodiments, the reservoir 22 may be omitted. In these embodiments, the first end of the hose 38 may be coupled directly to a water source (e.g., a hose spigot, a faucet, etc.).

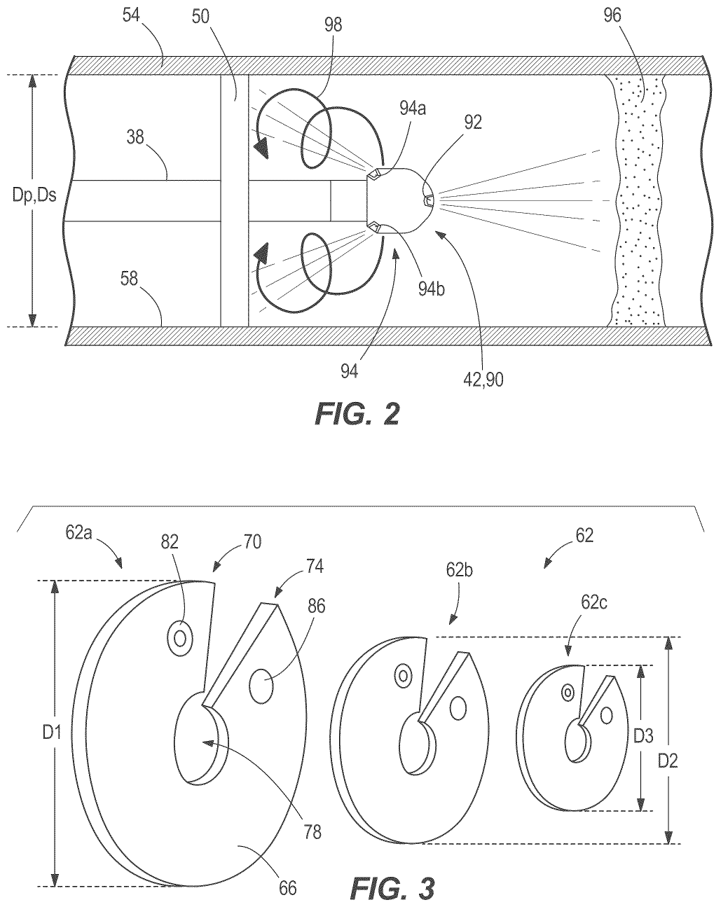

With reference to FIGS. 1 and 2, a scrubber 50 is coupled to the hose 38 adjacent the second end 42. The scrubber 50 may be removably or permanently coupled to the hose 38. In some embodiments, the scrubber 50 may be received in a groove in the hose 38. The scrubber 50 may be made of a flexible material (e.g., rubber). In some embodiments, the scrubber 50 may include bristles. In other embodiments, the scrubber 50 may be a solid or nearly solid disc. The scrubber 50 defines a scrubber diameter Ds. The scrubber 50 is configured to be received in a pipe 54, which defines a pipe diameter Dp. The pipe diameter Dp is the diameter of an inner surface 58 of the pipe 54. The illustrated scrubber diameter Ds is approximately equal to the pipe diameter Dp. As such, the scrubber 50 creates a seal with the inner surface 58 of the pipe 54. In some embodiments, the scrubber diameter Ds is larger than the pipe diameter Dp. In these embodiments, the scrubber 50 may bend or flex to create a seal with the inner surface 58 of the pipe 54. In some embodiments, the scrubber diameter Ds may be sufficiently large, such that the scrubber 50 may be used to create a seal with various sizes of pipe. In other embodiments, the scrubber 50 may not create a perfect seal with the pipe.

FIG. 3 illustrates a plurality of scrubbers 62, which may be removably coupled to the hose 38 in place of the scrubber 50. Similar to the scrubber 50, each of the plurality of scrubbers 62 is flexible and is configured to create a seal with a pipe. The plurality of scrubbers 62 includes a first scrubber 62a, a second scrubber 62b, and a third scrubber 62c. In some embodiments, the plurality of scrubbers 62 may include fewer or more scrubbers 62 (e.g., two, four, five, etc.). The first scrubber 62a defines a first diameter D1, the second scrubber 62b defines a second diameter D2 smaller than the first diameter D1, and the third scrubber 62c defines a third diameter D3 smaller than the second diameter D2. Each scrubber 62a, 62b, 62c is configured to be used with a different size range of pipes. Ideally, each scrubber 62a, 62b, 62c will be used with pipe sizes that are equal to or slightly greater than the diameter of the respective scrubber 62a, 62b, 62c. Each scrubber 62a, 62b, 62c includes a curved body 66 having a first end 70, a second end 74, and a central aperture 78. Each central aperture 78 has a diameter significantly equal to the diameter of the hose 38. In some embodiments, each central aperture 78 may have the same diameter. In other embodiments, each central aperture 78 may have a different diameter to fit differently sized hoses. Each scrubber 62a, 62b, 62c includes a quick-change attachment, which includes a first attachment portion 82 on the first end 70 and a second attachment portion 86 on the second end 74. The first and second attachment portions 82, 86 are configured to be removably coupled together (e.g., snapped, hooked, pressed, etc.) to secure the respective scrubber 62 to the hose 38.

As best illustrated in FIG. 2, the second end 42 of the hose 38 includes a plurality of nozzles 90. The illustrated plurality of nozzles 90 includes a primary nozzle 92 angled in a direction away from the scrubber 50 and a plurality of secondary nozzles 94 angled in a direction toward the scrubber 50. In some embodiments, there may be more primary nozzles 92 angled away from the scrubber 50 (e.g., two, three, four, etc.). The illustrated secondary nozzles 94 includes a first nozzle 94a and a second nozzle 94b. In some embodiments, there may be fewer or more secondary nozzles 94 angled toward the scrubber 50 (e.g., one, three, four, etc.). The illustrated primary nozzle 92 is larger than each of the respective secondary nozzles 94. Stated another way, the primary nozzle 92 outputs more liquid 24 per second than each of the respective secondary nozzles 94. The nozzles 90 are configured to spray the liquid 24 from the reservoir 22 into the pipe 54. The primary nozzle 92 is configured to spray a blockage 96 (e.g., grease, dirt, hair, etc.) that is constricting flow in the pipe 54. The secondary nozzles 94 are configured to create a vortex 98 (e.g., a helical flow of the liquid 24). The vortex 98 is configured to break down the blockage 96 into smaller pieces, which will make it easier to flush the blockage 96 down the pipe 54. In other embodiments, the second end 42 of the hose 38 may have different nozzle configurations. For example, the second end 42 may only include one or more primary nozzles 92 angled away from the scrubber 50. Alternatively, the second end 42 may only include one or more secondary nozzles 94 angled toward the scrubber 50.

Prior to operation, a user fills the reservoir 22 with the liquid 24 via the inlet. The user also couples one of the scrubbers 50, 62a, 62b, 62c to the hose 38. In embodiments using the plurality of scrubbers 62, the user chooses one of the respective scrubbers 62a, 62b, 62c depending on the size of the pipe being cleaned (e.g., the pipe 54). The user may then manipulate (e.g., pull, angle, spread apart, etc.) the first end 70 and the second end 74 to guide the central aperture 78 around the hose 38. The first and second ends 70, 74 may then be coupled together via the quick-change attachment. The user may also roll the drain cleaning device 10 via the wheels 30 to a desired location.

During operation, the user inserts the second end 42 of the hose 38 into the pipe 54, such that the scrubber 50, 62a, 62b, 62c creates a seal (or near seal) with the inner surface 58. The user then activates the pump 48 (e.g., via the pump activating member). The liquid 24 in the reservoir 22 begins to flow through the outlet of the reservoir 22, into the first end of the hose 38, through the body 46, and finally out through the nozzles 90. The liquid 24 sprayed from the primary nozzle 92 will impact and break down the blockage 96. The vortex 98 created by the liquid 24 sprayed from the secondary nozzles 94 will break down blockage 96 into smaller pieces. As the liquid 24 is sprayed into the pipe 54, pressure builds up in the pipe 54 between the scrubber 50, 62a, 62b, 62c and the blockage 96. The user may optionally slide the second end 42 of the hose 38 back and forth along the pipe 54 to adjust the pressure within the pipe 54. The blockage 96 will eventually become sufficiently broken down, such that the blockage 96 will be flushed down the pipe 54.

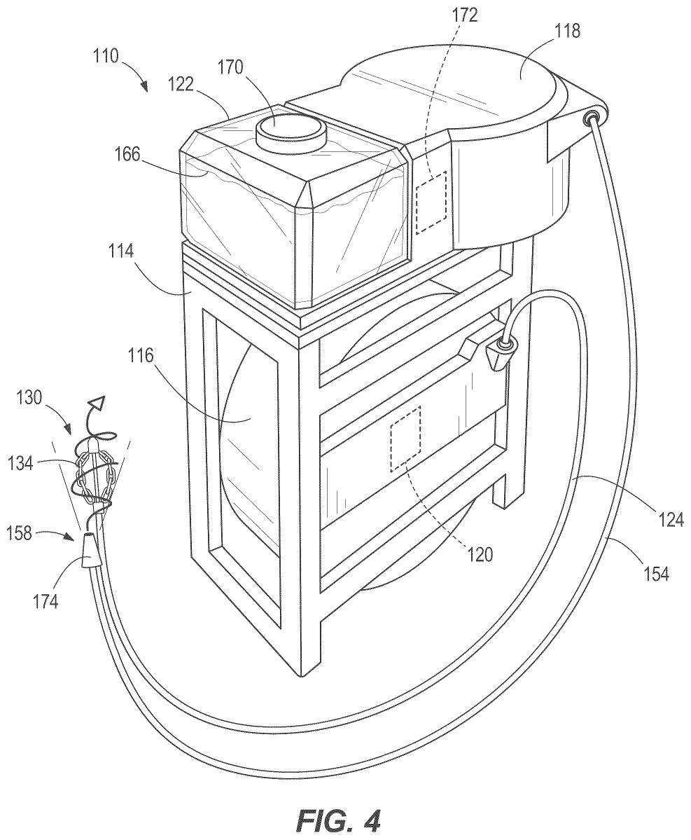

FIG. 4 illustrates another embodiment of a drain cleaning device 110 that is operable to clear and clean debris from pipes or other conduits. The drain cleaning device 110 includes a frame 114, a cable housing 116 supported by the frame 114, a hose housing 118 supported by the frame 114, and a reservoir 122 coupled to the hose housing 118 and supported by the frame 114. The drain cleaning device 110 may include wheels similar to the wheels 30 of the drain cleaning device 10. The drain cleaning device 110 may further include a battery receptacle for receiving and supporting a battery pack or support a power cord, similar to the drain cleaning device 10. The drain cleaning device 110 may include any additional features of the drain cleaning device 10 not discussed herein.

The cable housing 116 includes a motor 120 having a drive shaft. The motor 120 is configured to be selectively actuated by a motor actuating member (e.g., a foot switch, a button, etc.). The cable housing 116 defines a space, which supports a drain cleaning cable 124. The space may be defined by a drum assembly similar to the drum assembly 34 of the drain cleaning device 10.

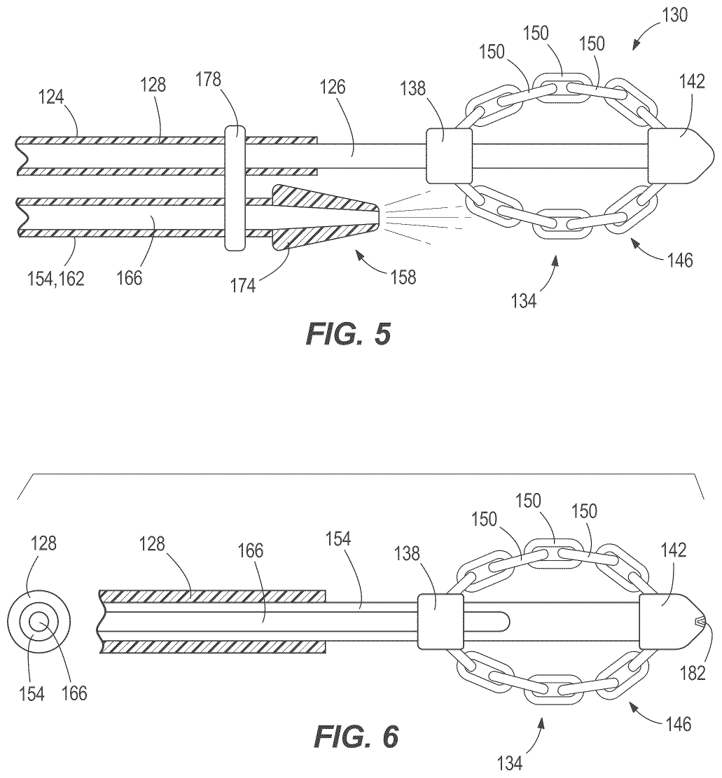

As best illustrated in FIG. 5, the drain cleaning cable 124 includes a wound cable 126 encased by a sheath 128. At a first end of the drain cleaning cable 124, the wound cable 126 is located within the cable housing 116 and is coupled to the drive shaft for co-rotation therewith. At a second end 130 of the drain cleaning cable 124, the wound cable 126 includes a drain cleaning attachment 134. The wound cable 126 receives torque from the motor 120 to rotate relative to the sheath 128. The sheath 128 may be coupled to the motor 120 or a portion of the cable housing 116. The second end 130 of the drain cleaning cable 124 is located outside the cable housing 116. The second end 130 and a body 132 of the drain cleaning cable 124 may be extended from and retracted into the drum assembly.

The drain cleaning attachment 134 is coupled to the second end 130 of the wound cable 126. The illustrated drain cleaning attachment 134 is a chain knocker, although other suitable drain cleaning attachments may also be used. The drain cleaning attachment 134 is configured to rotate with the wound cable 126 as the wound cable 126 is rotated by the drive shaft of the motor 120. The illustrated drain cleaning attachment 134 includes a first or inner mounting portion 138 coupled to the wound cable 126, a second or outer mounting portion 142 coupled to the wound cable 126, and a plurality of chains 146 therebetween. Each of the respective chains 146 is coupled to the mounting portions 138, 142. The illustrated drain cleaning attachment 134 includes two chains 146. In some embodiments, the drain cleaning attachment 134 may include fewer or more chains 146 (e.g., one, three, four, five, etc.). Each chain 146 includes a plurality of chain links 150. Each illustrated chain 146 includes five chain links 150. In some embodiments, each chain 146 may include fewer or more chain links 150 (e.g., three, four, six, seven, etc.). When the drain cleaning attachment 134 is rotated at a relatively high speed by the wound cable 126, the chains 146 extend radially outward to scrape and clean an inner surface of a pipe.

With reference to FIGS. 4 and 5, the hose housing 118 defines a space, which supports a drain cleaning hose 154. The space may be defined by a drum assembly similar to the drum assembly 34 of the drain cleaning device 10. The drain cleaning hose 154 is hollow and includes a first end, a second end 158 opposite the first end, and a body 162 therebetween. The first end is located within the hose housing 118 and is coupled to the reservoir 122. The second end 158 is located outside the hose housing 118. The body 162 is at least partially located within the space of the drum assembly. The second end 158 and the body 162 may be extended from and retracted into the drum assembly.

As illustrated in FIG. 4, the reservoir 122 is coupled to and positioned adjacent the hose housing 118. The reservoir 122 is configured to contain a liquid 166. The reservoir 122 includes a liquid inlet 170 on an outward facing surface and a liquid outlet on a surface facing the hose housing 118. The drain cleaning hose 154 is coupled to the outlet. A pump 172 may be located in the hose housing 118 to increase the flow rate of the liquid 166 from the reservoir 122 and through the hose 154. The pump 172 may be selectively activated by a pump activating member (e.g., a foot switch, a button, etc.). In some embodiments, the reservoir 122 may be omitted. In these embodiments, the first end of the drain cleaning hose 154 may be coupled directly to a water source (e.g., a hose spigot, a faucet, etc.).

As illustrated in FIGS. 4 and 5, the second end 158 of the drain cleaning hose 154 includes a nozzle 174. The illustrated nozzle 174 is located rearward of the drain cleaning attachment 134. The illustrated nozzle 174 is angled in a direction toward the drain cleaning attachment 134 and a blockage in a pipe (similar to the blockage 96 in the pipe 54). As such, the nozzle 174 is configured to spray the liquid 166 on the drain cleaning attachment 134. In some embodiments, the drain cleaning hose 154 may include more than one nozzle 174 (e.g., two, three, four, etc.). Additionally or alternatively, the nozzle(s) 174 may be located elsewhere relative to the drain cleaning attachment 134. For example, the nozzle(s) 174 may be located inside of a footprint of the chains 146 spraying the liquid 166 in any direction, may be located forward of the drain cleaning attachment 134 spraying the liquid 166 backward toward the drain cleaning attachment 134, or may be located in a combination of positions. The illustrated drain cleaning hose 154 is a separate hose that is coupled to the drain cleaning cable 124 via a fastener 178 (e.g., clip, elastic ring, etc.). The fastener 178 may removably or permanently couple the drain cleaning hose 154 to the drain cleaning cable 124. In some embodiments, the drain cleaning hose 154 may be permanently coupled (e.g., fused, glued, etc.) to the drain cleaning cable 124.

FIG. 6 illustrates another embodiment of the drain cleaning cable 124 and the drain cleaning hose 154 for use with the drain cleaning device 110. In the illustrated embodiment, the drain cleaning hose 154 replaces the wound cable 126. As such, the drain cleaning hose 154 is coupled to the drive shaft of the motor 120 for co-rotation therewith. The drain cleaning hose 154 is rotated by the motor 120 relative to the sheath 128. The drain cleaning attachment 134 is coupled to the second end 158 of the hose 154 for co-rotation therewith. The drain cleaning hose 154 is also coupled to the outlet of the reservoir 122 to receive the liquid 166. The outer mounting portion 142 of the drain cleaning attachment 134 includes a nozzle 182, which functions similar to the nozzle 174 to spray the liquid 166 from the reservoir 122. The illustrated nozzle 182 is angled in a direction away from the drain cleaning attachment 134 and towards a blockage in a pipe. In some embodiments, the hose 154 may include additional nozzles, which are angled to spray the drain cleaning attachment 134. For example, the hose 154 may include a plurality of nozzles located between the inner mounting portion 138 and the outer mounting portion 142 of the drain cleaning attachment 134. The plurality of nozzles may be angled in a direction generally perpendicular to the direction of the nozzle 182.

In this embodiment, the cable housing 116 and the hose housing 118 may be combined into a single, main housing. As such, the main housing may include a single drum assembly, which may be similar to the drum assembly 34 of the drain cleaning device 10. The drain cleaning hose 154 surrounded by the sheath 128 may be received in a space defined by the drum assembly.

Prior to operating the drain cleaning device 110, a user fills the reservoir 122 with the liquid 166 via the inlet 170. The user may also roll the drain cleaning device 110 via the wheels to a desired location.

During operation, the user inputs the second end 130 of the drain cleaning cable 124 and the second end 158 of the drain cleaning hose 154 into a pipe (similar to the pipe 54). The user activates the pump 172 (e.g., via the pump activating member) and actuates the motor 120 (e.g., via the motor actuating member). The pump 172 is activated independently of the motor 120. The liquid 166 in the reservoir 122 then flows through the outlet of the reservoir 122, into the first end of the hose 154, through the body 162, and finally out through the nozzle 174. The motor 120 rotates the drive shaft, which causes the wound cable 126 and the drain cleaning attachment 134 to rotate. The drain cleaning attachment 134 is configured to contact and break down a blockage in the pipe (similar to the blockage 96). The liquid 166 sprayed from the nozzle 174 is configured to further break down the blockage and also clean the chains 146. The user may optionally slide the second ends 130, 158 back and forth along the pipe to assist in breaking down the blockage. The blockage will eventually become sufficiently broken down, such that the blockage will be flushed down the pipe.

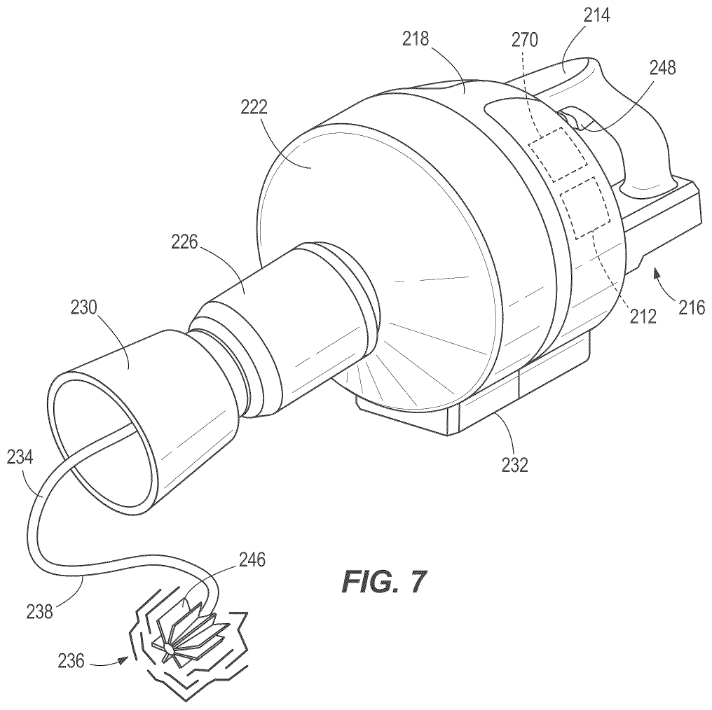

FIG. 7 illustrates another embodiment of a drain cleaning device 210 that is operable to clear and clean debris from pipes or other conduits. The drain cleaning device 210 includes a handle assembly 214, a shroud 218, a drum assembly 222, a nose assembly 226, and a sheath 230. The handle assembly 214 and the shroud 218 may together form a housing of the drain cleaning device 210. In one embodiment, the shroud 218 may be a drum shield. The drum assembly 222 may be similar to the drum assembly 34 of the drain cleaning device 10. The drain cleaning device 210 also includes a stand 232. The stand 232 is positioned generally beneath the shroud 218 and the drum assembly 222. The stand 232 includes a generally planar surface that is configured to engage and rest on a support surface (e.g., a table, a workbench, a countertop, the floor, etc.). The drain cleaning device 210 also includes a motor 212 which may be positioned within the handle assembly 214 and/or the shroud 218. The motor 212 includes a drive shaft that is selectively actuated. The drain cleaning device 210 further includes a drain cleaning cable 234 that is stored within the drum assembly 222 and extends out of the sheath 230. The cable 234 is a flexible cable.

The handle assembly 214 extends rearwardly from the shroud 218. The handle assembly 214 is configured to be grasped by a user for carrying and operating the drain cleaning device 210. The handle assembly 214 supports an actuator 248 (e.g., a trigger). The actuator 248 is actuatable (e.g., depressible) by a user to selectively energize the motor 212 and, thereby, operate the drain cleaning device 210. The illustrated handle assembly 214 may also include a battery receptacle 216 for receiving and supporting a battery pack, such as a power tool battery pack. In other embodiments, the handle assembly 214 may support a power cord to electrically connect the motor 212 to an AC power source.

The illustrated nose assembly 226 may provide a lock mechanism for the drain cleaning device 210. In particular, the nose assembly 226 may be slidable toward and away from the drum assembly 222 to selectively lock and unlock the cable 234. When the nose assembly 226 is in the locked position, the cable 234 may not be extended from the drum assembly 222. When the nose assembly 226 is in the unlocked position, the cable 234 may be extended from the drum assembly 222.

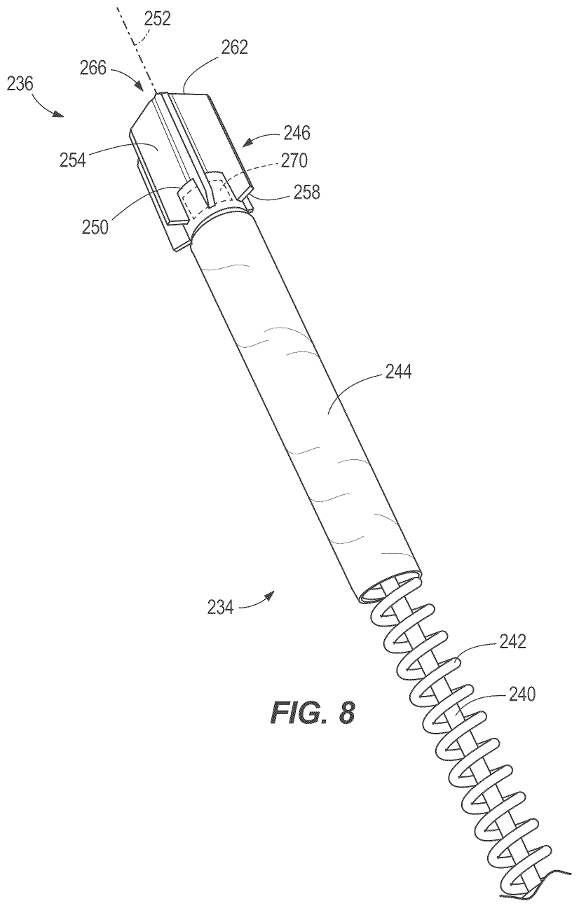

With reference to FIGS. 7 and 8, the cable 234 includes a first end, a second end 236 opposite the first end, and a body 238 therebetween. The first end is located within the drum assembly 222 and is coupled to the drive shaft for co-rotation therewith. The second end 236 and the body 238 may be extended from and retracted toward the drum assembly 222. As best illustrated in FIG. 8, the cable 234 includes an inner cable 240 surrounded by a cable sheath 242. The cable sheath 242 is surrounded by an insulating coating 244. In the illustrated embodiment, the cable sheath 242 is partially surrounded by the insulating coating 244. In other embodiments, the entire cable sheath 242 may be surrounded by the insulating coating 244. In some embodiments, the insulating coating 244 may have sufficient insulating qualities to allow a user to grasp the insulating coating 244 during operation of the drain cleaning device 210. In some embodiments, the inner cable 240 may only be surrounded by the cable sheath 242. In these embodiments, the cable sheath 242 may have insulating qualities. The illustrated inner cable 240, cable sheath 242, and insulating coating 244 are configured to rotate with the drive shaft of the motor 212. In some embodiments, the inner cable 240 may be configured to rotate with the drive shaft relative to the cable sheath 242 and the insulating coating 244.

With continued reference to FIGS. 7 and 8, a head 246 is coupled to the second end 236 of the cable 234. The head 246 may be removably or permanently coupled to the second end 236. In some embodiments, the head 246 may be integrally formed with the cable 234. The illustrated head 246 includes a central shaft 250. The central shaft 250 defines a longitudinal axis 252. The illustrated head 246 also includes a plurality of fins 254 extending radially from a central shaft 250. The fins 254 are aligned with the longitudinal axis 252. Each of the respective fins 254 includes a first side 258 adjacent the cable 234 and a second side 262 opposite the first side 258. The first side 258 extends in a direction generally perpendicular with the longitudinal axis 252. The second side 262 extends in a direction that defines an acute angle when measured between the second side 262 and the central shaft 250. As such, the head 246 defines a tip 266. In other embodiments, the head 246 may have other configurations.

The head 246 is configured to be heated up by a heater element 270. In some embodiments, the heater element 270 may be located in the head 246 (shown in FIG. 8). In these embodiments, the heater element 270 may directly heat up the head 246. In other embodiments, the heater element 270 may be located in another part of the drain cleaning device 210. For example, FIG. 7 illustrates the heater element 270 positioned within the shroud 218. In these embodiments, heat generated by the heater element 270 may be carried along the cable 234 (e.g., via the inner cable 240) to the head 246. In some embodiments, the heater element 270 may be an electrical heater element. For example, the head 246 may include a resistor. The resistor may receive electrical current and convert the electrical energy into heat to raise the temperature of the head 246. In other embodiments, the heater element 270 may be a mechanical heater element. For example, the head 246 may include a moving (e.g., vibrating, rotating, etc.) element that is configured to frictionally contact a stationary element. The friction between the elements will convert kinetic energy into heat to raise the temperature of the head 246. The heat generated by the heater element 270 may be controlled by the actuator 248 or a separate heating controller (e.g., dial, button, etc.). The heater element 270 may be configured to heat the head 246 to a desired temperature. For example, a user may desire for the head 246 to be sufficiently hot to melt a blockage (e.g., grease) but not too hot, such that the head 246 will melt a pipe (e.g., composed of PVC). The head 246 is configured to be completely received within the sheath 230 when the cable 234 is fully retracted. As such, the head 246 is inhibited from accidentally interacting with the environment.

During operation, a user extends the cable 234 out of the drum assembly 222 and inserts the second end 236 into a pipe (similar to the pipe 54). The user then activates the motor 212 (e.g., via the actuator 248) and activates the heater element 270 (e.g., via the actuator 248 or the separate heating controller). The motor 212 rotates the drive shaft, which causes the cable 234 and the head 246 to rotate. The heater element 270 creates heat, which is transferred to the head 246. As such, the head 246 heats up to reach the desired temperature. The user may slide the heated and rotating head 246 into contact with a blockage (similar to the blockage 96). For example, the tip 266 may puncture through the blockage. The head 246 may melt and/or break the blockage into smaller pieces. The fins 254 increase a surface area of the head 246 that can contact and heat up the blockage. The fins 254 also help pierce and cut through the blockage. The user may optionally slide the second end 236 back and forth along the pipe to assist in breaking down the blockage. The blockage will eventually become sufficiently melted and/or broken down, such that the blockage will be flushed down the pipe.

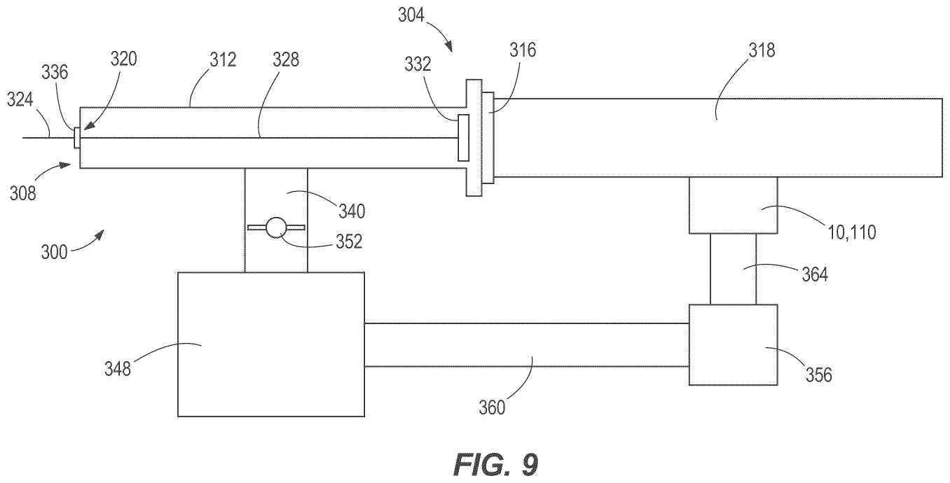

FIG. 9 illustrates a pipe attachment 300 that may be used with the drain cleaning device 10, 110. The pipe attachment 300 includes a first end 304, a second end 308 opposite the first end 304, and a body 312 therebetween. The first end 304 is configured to removably couple to a cover 316 of a pipe 318. The pipe 318 includes material (e.g., a blockage, liquid, etc.). The second end 308 includes an aperture 320. The aperture 320 is configured to receive a shaft 324 of a saw (e.g., a hole saw 328). The hole saw 328 includes a cutting portion 332, which is housed within the body 312. The cutting portion 332 is configured to cut a hole through the cover 316 to remove the material from the pipe 318. An O-ring 336 is located adjacent the aperture 320 to prevent the material from exiting the pipe attachment 300 through the aperture 320. The pipe attachment 300 includes an outlet portion 340 extending from the body 312. The outlet portion 340 includes an outlet aperture 344, which is configured to be adjacent a holding tank 348. The holding tank 348 is configured to temporarily store the material. The illustrated outlet portion 340 includes a valve 352 (e.g., a ball valve, a gate valve, etc.) to control a flow of the material through the outlet aperture 344 and into the holding tank 348.

With continued reference to FIG. 9, the material may be recirculated back into the pipe 318. A pump 356 may direct the material through a first pipe 360 disposed between the holding tank 348 and the pump 356, through a second pipe 364 disposed between the pump 356 and the drain cleaning device 10, 110, and into the drain cleaning device 10, 110. The drain cleaning device 10, 110 may then use the material in place of the liquid 24, 166 during operation.

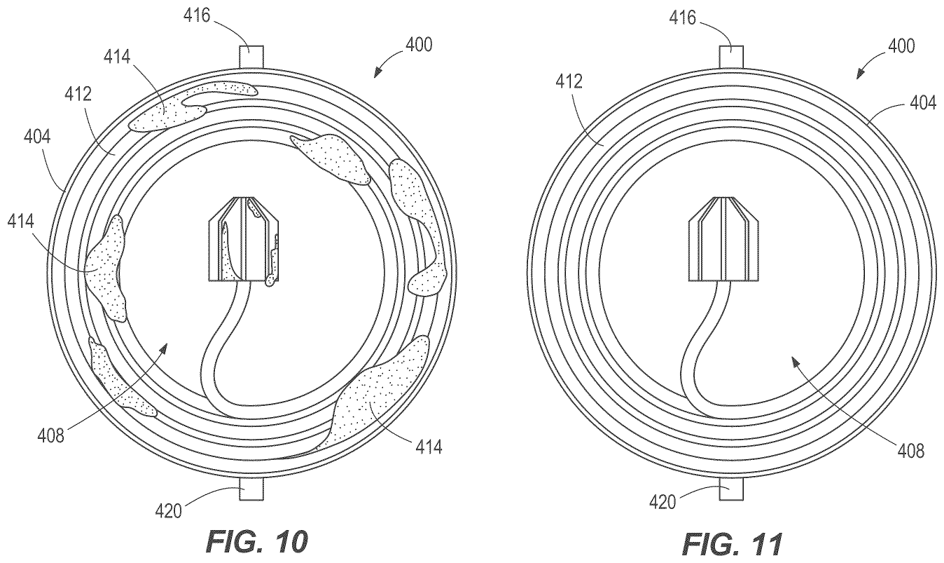

FIGS. 10 and 11 illustrate a drum 400 that may be used in a drum assembly of the drain cleaning device 10, 110, 210. The drum 400 includes a housing 404 defining a space 408 therein. The space 408 is configured to house a cord 412. The cord 412 may be the hose 38 of the drain cleaning device 10, the cable 124 or the hose 154 of the drain cleaning device 110, or the cable 234 of the drain cleaning device 210. The space 408 may include debris 414 (e.g., dirt, mud, grease, etc.). For example, during operation, the cord 412 may be extended from the drum 400 and the debris 414 may couple (e.g., stick) to the cord 412. Retracting the cord 412 will bring the debris 414 inside the drum 400.

An inlet port 416 and an outlet port 420 extend from the housing 404. The inlet port 416 is configured to be coupled to a liquid source (e.g., a hose) to receive a liquid (e.g., water, cleaning fluid, etc.). The outlet port 420 is configured to drain the liquid from the drum 400. In some embodiments, the outlet port 420 may be configured to be coupled to a hose. In other embodiments, the drum 400 may include a single port that functions as both the inlet port and the outlet port.

FIG. 10 illustrates the drum 400 including the debris 414. A user may remove the debris 414 from the drum 400 by first inputting the liquid into the drum 400. The user may then spin the drum 400 (e.g., by a motor, manually, etc.) to de-couple the debris 414 from the cord 412. The user may then drain the liquid and the debris 414 from the drum 400 via the outlet port 420. FIG. 11 illustrates the drum 400 without any of the debris 414.

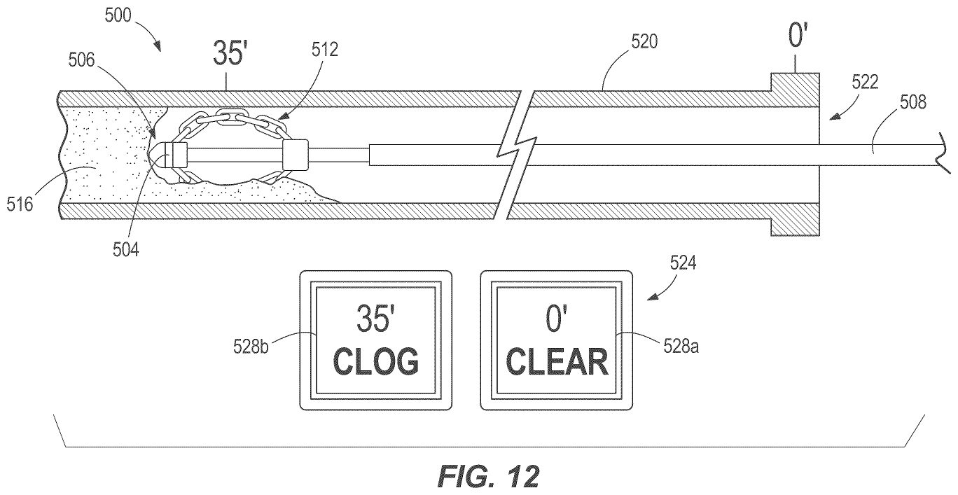

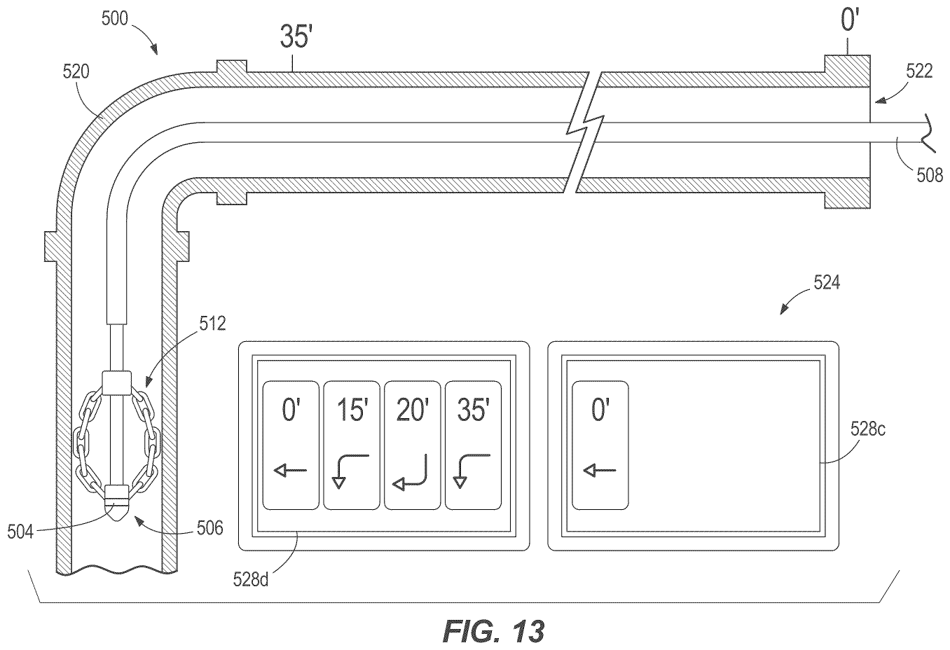

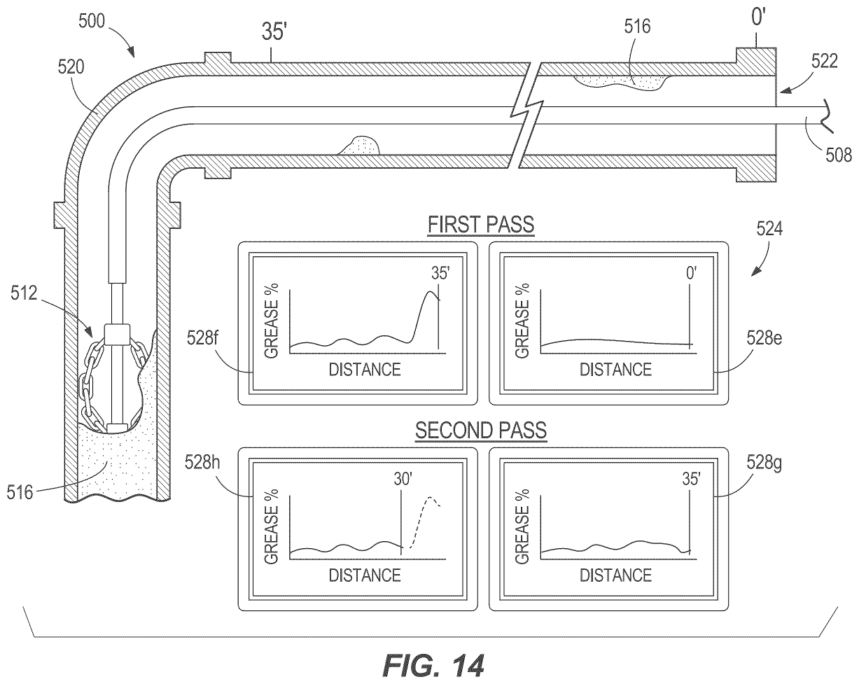

FIGS. 12-14 illustrate a clog sensing system 500 that may be used in the drain cleaning device 10, 110, 210. The clog sensing system 500 includes a sensor 504 (e.g., an encoder, a switch, an inertial measurement unit, an accelerometer, a gyroscope, a capacitive dielectric sensor, a resistive sensor, a temperature sensor, etc.) disposed on an end 506 of a cord 508. The cord 508 may be the hose 38 of the drain cleaning device 10, the cable 124 or the hose 154 of the drain cleaning device 110, or the cable 234 of the drain cleaning device 210. The sensor 504 may be adjacent a drain cleaning attachment 512. The drain cleaning attachment 512 may be the scrubber 50, 62a, 62b, 62c, the drain cleaning attachment 134, the nozzle 174, or the head 246. The end 506 is configured to be inserted into a pipe 520. The sensor 504 is configured to identify a plurality of characteristics of the pipe 520. The characteristics are then output on a display 524. The display 524 may be a user's smartphone or computer (e.g., a laptop, a tablet, etc.), or may be a dedicated monitor for use with a drain cleaner. The display 524 in FIGS. 12 and 13 illustrates numerical values associated with respective example movements of the drain cleaning device 10, 110, 210 through the pipe 520, and the display in FIG. 14 illustrates data in graphical form associated with an example movement of the drain cleaning device 10, 110, 210 through the pipe 520. It should be appreciated that the numerical values and data illustrated on the display 524 are in response to non-limiting examples of movement of the drain cleaning device 10, 110, 210.

With specific reference to FIG. 12, the sensor 504 is configured to identify a location of a blockage 516 (e.g., grease, dirt, hair, etc.) in the pipe 520. As the end 506 is slid along the pipe 520, the sensor 504 tracks a distance moved by the end 506. The illustrated display 524 displays two characteristics. The first characteristic is the distance traveled by the end 506. The second characteristic is a detection status. The detection status may indicate if the blockage 516 is located or not. For example, the detection status may be ‘CLEAR’ if the blockage 516 is not located and ‘CLOG’ if the blockage 516 is located. FIG. 12 denotes a first output 528a of the display 524 when the end 506 is located at an entrance 522 to the pipe 520 and a second output 528b of the display 524 after the end 506 has traveled thirty-five feet along the pipe 520. The first output 528a indicates a distance traveled of zero feet and a detection status of ‘CLEAR.’ As such, the first output 528a indicates the blockage 516 is not at this location. As the end 506 is slid further (i.e., thirty-five feet) into the pipe 520, the display displays the second output 528b. The second output 528b indicates a distance traveled of thirty-five feet and a detection status of ‘CLOG.’ As such, the second output 528b indicates that the blockage is located at this location (i.e., thirty-five feet into the pipe 520).

With specific reference to FIG. 13, the sensor 504 is configured to identify a path taken by the end 506. As the end 506 is slid along the pipe 520, the sensor 504 tracks a distance moved by the end 506 and any turns or changes in direction made by the end 506. As such, the display 524 illustrates a map of the pipe 520. The illustrated display 524 displays two characteristics. The first characteristic is the distance traveled by the end 506. The second characteristic is the turns made by the end 506. FIG. 13 denotes a third output 528c of the display 524 when the end 506 is located at the entrance 522 to the pipe 520 and a fourth output 528d of the display 524 after the end 506 has traveled along the pipe 520. The third output 528c indicates that the end 506 has not moved within the pipe 520. The fourth output 528d indicates that the end 506 has moved in a first direction for fifteen feet. At fifteen total feet of travel, the end 506 turned left relative to the first direction and traveled in a second direction for five feet (i.e., twenty total feet of travel). At twenty total feet of travel, the end 506 turned right relative to the second direction and traveled in a third direction for fifteen feet (i.e., thirty-five total feet of travel). At thirty-five total feet of travel, the end 506 turned left relative to the third direction. In some embodiments, the distance traveled and turns made by the end 506 may be displayed in a different fashion.

With specific reference to FIG. 14, the sensor 504 is configured to identify an amount of the blockage 516 throughout the pipe 520. As the end 506 is slid along the pipe 520, the sensor 504 tracks a distance moved by the end 506 and a quantity of the blockage 516 at a point in the pipe 520. For example, the quantity of the blockage 516 may be measured as an area that the blockage 516 takes up in the pipe 520. The illustrated display 524 displays a graph of the quantity of the blockage 516 at each incremental point in the pipe 520. FIG. 14 illustrates outputs of the display 524 during a first pass of the drain cleaning attachment 512 through the pipe 520 and a second pass of the drain cleaning attachment 512 through the pipe 520. Data from the first pass includes a fifth output 528e of the display 524 when the end 506 is at the entrance 522 of the pipe 520 and a sixth output 528f of the display 524 after the end 506 travels thirty-five feet along the pipe 520. The fifth output 528c illustrates that there is very little, if any, of the blockage 516 at the entrance of the pipe 520. The sixth output 528f illustrates two portions along the length of the pipe 520 that include a small amount of the blockage 516 and one portion along the length of the pipe 520 that includes a significant amount of the blockage 516 (i.e., at about thirty-five feet). Data from the second pass includes a seventh output 528g of the display 524 after the end 506 has traveled thirty feet along the pipe 520 and an eighth output 528h of the display 524 after the end 506 has traveled thirty-five feet along the pipe 520. The seventh and eighth outputs 528g, 528h indicate that the location that included a significant amount of the blockage 516 during the first pass (i.e., at about thirty-five feet) now has a small amount of the blockage 516. As such, the drain cleaning attachment 512 removed a significant amount of the blockage 516 during the first pass.

The illustrated sensor 504 is configured to identify the location of the blockage 516 (FIG. 12), the path of the end 506 (FIG. 13), and the amount of the blockage 516 throughout the pipe 520 (FIG. 14). In some embodiments, the clog sensing system 500 may include multiple sensors similar to the sensor 504, each of which are configured to identify a specific characteristic of the pipe 520. The illustrated display 524 is configured to be switched between views. For example, when the end 506 is at the pipe entrance 522 and has not yet made a pass through the pipe 520, a user may manually switch, or the display 524 may automatically rotate, between the first output 528a, the third output 528c, and the fifth output 528c. In some embodiments, the clog sensing system 500 may include multiple displays similar to the display 524, each of which is configured to show a specific view. FIGS. 12-14 illustrates eight outputs 528a-528h of the display 524. In some embodiments, the display 524 may provide real-time date outputs (i.e., the display is constantly updated as the end 506 travels along the pipe 520). In other embodiments, the display 524 may provide data outputs at periodic intervals (e.g., every one foot traveled by the end 506).

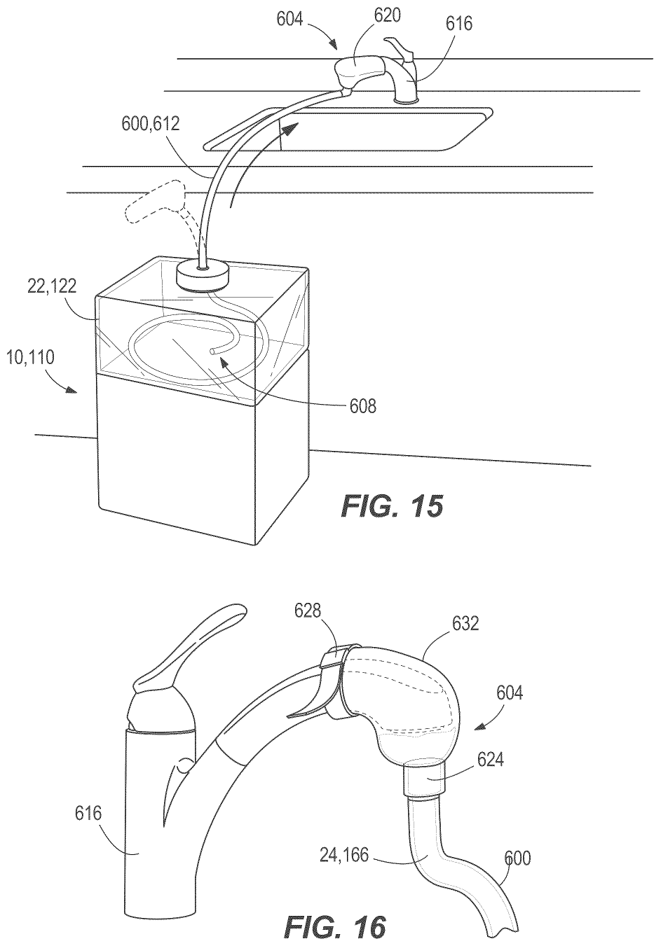

FIGS. 15 and 16 illustrate a hookup hose 600 configured to be used with the drain cleaning device 10, 110. In some embodiments, the hookup hose 600 may be used to fill up the reservoir 22, 122 with the liquid 24, 166. In other embodiments, the hookup hose 600 may bypass the reservoir 22, 122 and provide the liquid directly to the hose 38, 154. The hookup hose 600 includes a first end 604, a second end 608, and a hollow body 612 therebetween. The first end 604 is configured to receive the liquid 24, 166 from a liquid source 616 (e.g., a faucet, a spigot, etc.). The second end 608 is configured to be coupled to or inserted into the desired component of the drain cleaning device 10, 110. FIG. 15 illustrates the second end 608 inserted into the inlet of the reservoir 22, 122. A universal hookup 620 is coupled to the second end 608. The universal hookup 620 includes a connection portion 624, a synch strap 628, and a flexible fabric 632 therebetween. The connection portion 624 is configured to couple to the first end 604 of the hookup hose 600. The flexible fabric 632 is configured to conform to the shape of the liquid source 616. The flexible fabric 632 is sufficiently large to conform to the shape of essentially any liquid source. The synch strap 628 is configured to secure the universal hookup 620 to the liquid source 616. The synch strap 628 is further configured to create a seal with the liquid source 616 to inhibit the liquid 24, 166 from escaping between the synch strap 618 and the liquid source 616.

During operation, a user may quickly place the flexible fabric 632 over the liquid source 616 and secure the synch strap 628 to the liquid source 616. The user couples the connection portion 624 to the first end 604 of the hookup hose 600 and inserts the second end 608 of the hookup hose 600 into the inlet of the reservoir 22, 122. The user may then turn on the flow of the liquid 24, 166 from the liquid source 616. When the reservoir 22, 122 is sufficiently full, the user may cut the flow of the liquid 24, 166. The user may then remove the synch strap 628 from the liquid source 616 and remove the second end 608 of the hookup hose 600 from the inlet of the reservoir 22, 122.

Various features of the disclosure are set forth in the following claims.

What is claimed is:

1. A drain cleaning device configured to be used in a pipe defining a pipe diameter, the drain cleaning device comprising:
a frame;
a drum assembly supported by the frame;
a flexible hose positioned at least partially within the drum assembly, the flexible hose configured to be extended from and retracted into the drum assembly, the flexible hose defining a first end and a second end opposite the first end; and
a flexible scrubber adjacent the second end of the flexible hose,
wherein the flexible hose includes a first nozzle angled in a direction away from the flexible scrubber and a second nozzle angled in a direction toward the flexible scrubber.

2. The drain cleaning device of claim 1, wherein the flexible scrubber is configured to create a seal with the pipe.

3. The drain cleaning device of claim 1, wherein the second nozzle is one of a plurality of second nozzles, and wherein each of the plurality of second nozzles is angled in a direction toward the flexible scrubber.

4. The drain cleaning device of claim 1, wherein
the flexible scrubber is removably coupled to the flexible hose,
the flexible scrubber is one of a plurality of flexible scrubbers, and
each of the plurality of flexible scrubbers defines a different diameter.

5. The drain cleaning device of claim 1, further comprising a reservoir supported by the frame, wherein the first end of the flexible hose is coupled to the reservoir.

6. The drain cleaning device of claim 1, wherein the flexible scrubber defines a scrubber diameter greater than the pipe diameter, and wherein the flexible scrubber flexes to fit within the pipe.

7. A drain cleaning device comprising:
a frame;
a housing supported by the frame;
a motor located within the housing;
a flexible cable positioned at least partially within the housing, the flexible cable configured to be extended from and retracted into the housing, the flexible cable defining a first end and a second end opposite the first end, the first end coupled to the motor to receive torque from the motor;
a flexible hose positioned at least partially within the housing, the flexible hose configured to be extended from and retracted into the housing, the flexible hose defining a first end and a second end opposite the first end;
a rotating cleaning attachment coupled to the second end of the flexible cable; and
a nozzle coupled to the second end of the flexible hose.

8. The drain cleaning device of claim 7, wherein the flexible cable is coupled to the flexible hose.

9. The drain cleaning device of claim 7, wherein the flexible hose is disposed within the flexible cable.

10. The drain cleaning device of claim 7, wherein
the flexible cable includes an inner cable surrounded by a sheath,
the inner cable is coupled to the motor to receive torque from the motor, and
the inner cable rotates relative to the sheath.

11. The drain cleaning device of claim 7, wherein the housing includes a first drum assembly and a second drum assembly, wherein the flexible cable is positioned at least partially within the first drum assembly, and wherein the flexible hose is positioned at least partially within the second drum assembly.

12. The drain cleaning device of claim 7, further comprising a reservoir supported by the frame and a pump configured to draw a liquid from the reservoir and propel the liquid through the flexible hose and out the nozzle, wherein the first end of the flexible hose is coupled to the reservoir.

13. The drain cleaning device of claim 12, wherein the nozzle is angled in a direction toward the rotating cleaning attachment.

14. A drain cleaning device comprising:
a housing;
a motor located within the housing;
a drum assembly supported by the housing;
a flexible cable positioned at least partially within the drum assembly, the flexible cable configured to be extended from and retracted into the drum assembly, the flexible cable defining a first end and a second end opposite the first end, the first end coupled to the motor to receive torque from the motor;
a heating head coupled to the second end of the flexible cable; and
a heater element configured to transfer heat to the heating head.

15. The drain cleaning device of claim 14, wherein the heater element is located within the housing, and wherein the heat is configured to be transferred from the heater element, through the flexible cable, and to the heating head.

16. The drain cleaning device of claim 14, wherein the heater element is located within the heating head.

17. The drain cleaning device of claim 14, further comprising a sheath coupled to the drum assembly, and wherein the heating head is configured to be retracted into the sheath.

18. The drain cleaning device of claim 14, wherein the heater element is an electrical heater element.

19. The drain cleaning device of claim 14, wherein the heater element is a mechanical heater element.

20. The drain cleaning device of claim 14, wherein the flexible cable includes an insulating coating.
